(19) United States
(12) Patent Application Publication
(10) Pub. No.: US 2012/0240721 A1
(43) Pub. Date: Sep. 27, 2012

(54) STEERING WHEEL

(75) Inventor: Laurent Groleau, Quincay (FR)

(73) Assignee: AUTOLIV DEVELOPMENT AB, Vårgårda (SE)

(21) Appl. No.: 13/513,938

(22) PCT Filed: Oct. 25, 2010
(86) PCT No.: PCT/SE2010/051152

§ 371 Date: Jun. 5, 2012

(30) Foreign Application Priority Data
Dec. 10, 2009 (GB) 0921658.1

(51) Int. Cl. G05G 1/10

(52) U.S. Cl. 74/558

(57) ABSTRACT

A steering wheel has a gripping portion including an armature substantially encapsulated by a cover, and an outer skin provided over the cover. The outer skin comprises a layer of fabric material defining first and second opposed surfaces. The first surface of the fabric material has a polymeric coating. The first surface is attached to the outermost surface of the cover and the second surface defines a peripheral surface of the gripping portion. Preferably, the second surface of the fabric layer is substantially uncoated. In preferred arrangements, the second surface of the fabric layer has a surface relief pattern substantially defined by a weave of the fabric and thus defines a peripheral surface pattern.

The present invention relates to a steering wheel, for example of the sort found in motor vehicles.

Conventional steering wheels suitable for use in motor vehicles typically comprise a metal frame having a central boss from which one or more spokes extend in a generally radial direction. A generally circular or near-circular metal armature is supported by the radially outermost ends of the spokes in order to define part of a peripheral rim of the steering wheel, to be gripped by the driver of the vehicle. The armature is typically covered by a foam covering, and the foam covering is finished with an outer skin. The outer skin is applied over the foam covering to provide a visually and haptically pleasing peripheral surface to the steering wheel. It is conventional for the outer skin to be provided with a surface relief pattern of some sort, partly to improve the appearance and feel of the steering wheel, but also to provide an appropriate level of friction between the wheel and the hands of the driver to ensure the wheel can be properly gripped in use.

EP1055582 discloses a steering wheel construction of the general type proposed above. More particularly, EP1055582 proposes the use of a secondary grade of leather (effectively obtained as a bi-product arising from the production of top grade leather more suitable for use as interior upholstery in the vehicle) in the creation of an outer skin on the steering wheel. The rim of the steering wheel comprises a foam covering provided over a central armature. A substrate of the secondary grade leather is applied directly to the foam covering, and then a moulded film of polyurethane is adhered to the leather substrate. The outer surface of the polyurethane film is provided with a moulded grain pattern, and is painted.

As will be appreciated, the arrangement of EP1055582 thus relies on a moulded surface relief pattern to provide the desired texture to the peripheral surface of the steering wheel rim. This is actually a very common proposal. However, a problem with this sort of arrangement is that the relief pattern can be perceived as having a somewhat “artificial” appearance when compared to, say, a more expensive leather-bound steering wheel rim. Attempts to improve the visual appearance of moulded relief patterns can significantly increase the cost of the moulding process. Also, it can be difficult to hide moulding marks which inevitably arise from the moulding process, such as, for example, the occurrence of flash marks resulting from leakage of the moulding material between separable parts of the mould tool.

It is an object of the present invention to provide an improved steering wheel.

According to the present invention, there is provided a steering wheel having a gripping portion comprising an armature substantially encapsulated by a cover, and an outer skin provided over the cover, the outer skin comprising a layer of fabric material defining first and second opposed surfaces, said first surface of the fabric material having a polymeric coating, the steering wheel being characterised in that the outer skin is attached to the outermost surface of the cover such that the coating is interposed between the fabric layer and the cover, and said second surface defines a peripheral surface of said gripping portion.

Preferably, said second surface of the fabric layer is substantially uncoated.

Alternatively, said second surface of the fabric layer is provided with a coating, or is painted.

Advantageously, said second surface of the fabric layer has a surface texture substantially defined by the weave of the fabric.

Optionally, said polymeric coating has a textured surface.

Preferably, said polymeric coating has a substantially smooth surface.

Conveniently, said polymeric coating is provided in the form of a foam layer applied to the fabric layer.

Preferably, said polymeric coating comprises polyvinylchloride.

Advantageously, said polymeric coating comprises polyurethane.

Conveniently said polymeric coating comprises polychloroprene (more commonly known as “Neoprene”)

Optionally, the coating is adhesively secured to the fabric material.

Preferably the cover is formed of foam material.

Advantageously the foam material of the cover comprises thermoplastic material.

Conveniently the foam material of the cover comprises polyurethane.

Advantageously, the coated first surface of the fabric layer is adhesively attached to the cover.

So that the invention may be more readily understood, and so that further features thereof may be appreciated, embodiments of the invention will now be described by way of example with reference to the accompanying drawings in which:

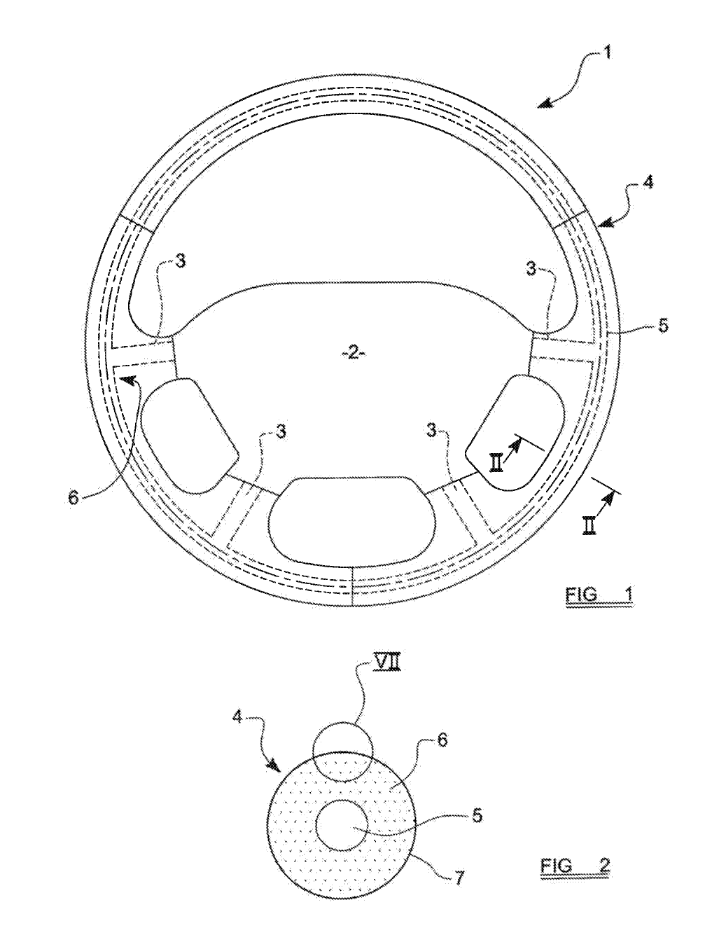

FIG. 1 is a schematic illustration of a steering wheel in accordance with the present invention;

FIG. 2 is a cross-sectional view taken along line II-II on FIG. 1, through the rim of the steering wheel;

FIG. 3 is a schematic cross-sectional view showing the construction of an outer skin used to form part of the rim of the steering wheel;

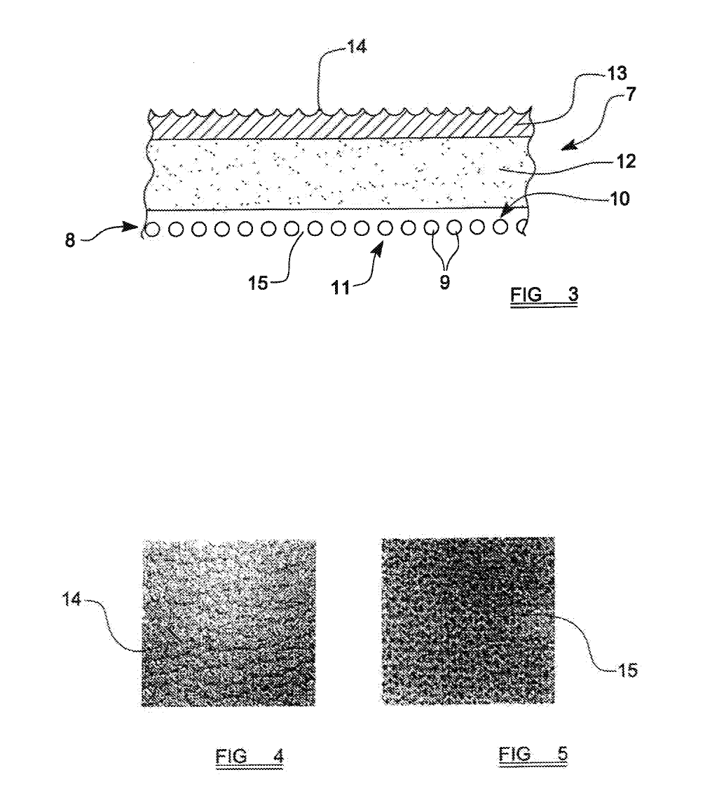

FIG. 4 is a schematic illustration showing a first surface of the outer skin shown in FIG. 3;

FIG. 5 is a schematic illustration showing an opposed second surface of the outer skin shown in FIG. 3;

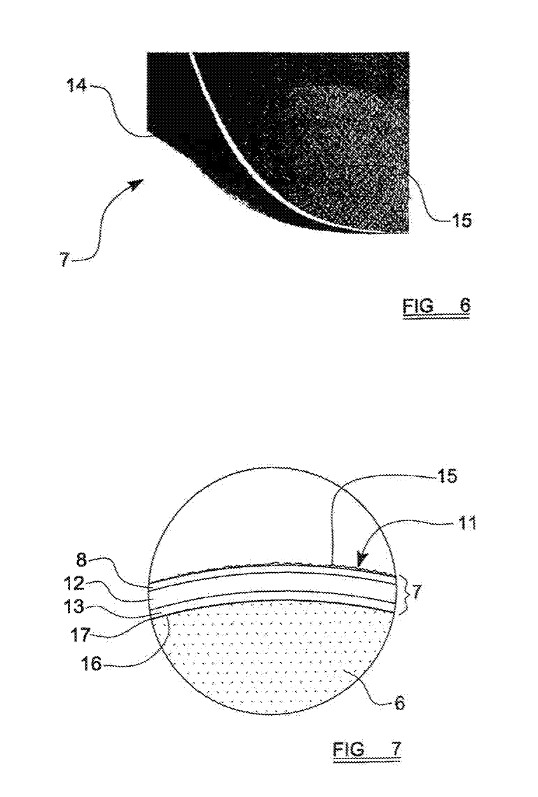

FIG. 6 is a perspective view of the outer skin of FIGS. 3 to 5, showing regions of both surfaces; and

FIG. 7 is an enlarged view of region VII shown on FIG. 2, showing the outer skin applied to the rim of the steering wheel.

Referring initially to FIG. 1 of the drawings, there is illustrated a steering wheel 1 comprising a central hub 2 from which a plurality of spokes 3 extend substantially radially, the spokes supporting an outer rim 4. More particularly, it is to be noted that the radially outermost ends of the spokes 3 support a generally circular or approximately circular metal armature 5 (illustrated in dashed lines in FIG. 1). Together, the hub 2, spokes 3, and armature 5 of the steering wheel can be considered to form an integral frame. The armature 5, and optionally at least a region of the spokes 3 (which together may be considered to represent a gripping portion of the wheel suitable to be gripped by the driver), may be provided with a foam cover 6. The foam cover may, for example, comprise polyurethane foam. In the arrangement illustrated in FIG. 1, the foam cover 6 serves to completely encapsulate the underlying armature 5 whilst also covering the radially outermost region of each spoke 3. As thus far described, the steering wheel 1 is generally conventional.

As shown in FIG. 2, the foam cover 6 is wrapped with an outer skin 7. The present invention most particularly concerns the outer skin 7, and in particular its construction and orientation relative to the foam cover 6.

Turning now to consider FIG. 3, the cross-sectional structure of the outer skin 7 is shown in detail. The outer skin 7 comprises a layer or substrate of fabric material 8, which is woven from a plurality of warp and weft yarns 9 according any convenient weave pattern. The fabric layer 8 thus defines first and second opposed surfaces 10, 11, both of which have a surface texture which is substantially defined by the weave of the fabric.

The first surface 10 of the fabric layer 8 (i.e. the uppermost surface in the orientation illustrated in FIG. 3) has a polymeric coating 12 applied to it. In preferred embodiments, the polymeric coating 12 is moulded on the first surface 10 of the fabric, so as to form a foam layer on the fabric. The polymeric material used to create this foam layer can comprise polyurethane or polyvinylchloride, although it is envisaged that other suitable polymeric substances could also be used. A skin 13 is created on the outer surface of the foam layer 12, and may have a fine surface texture or “grain” arising from the surface of the mould tool used to create the layer. FIG. 4 shows an exemplary surface texture 14 for the foam skin 13. However, it is not essential to the present invention that the skin 13 has such a surface texture, and indeed it is preferred that that the skin 13 is substantially smooth.

As will be appreciated, the polymeric material from which the foam layer 12 is formed will at least partially fill the interstices between adjacent yarns 9 of the fabric on the side of the first (upper) surface 10. However, the polymeric material is unable, or is not permitted, to penetrate significantly through the fabric layer 8, and so the second surface 11 (i.e the lower surface of the fabric layer 8 in the orientation shown in FIG. 3) retains its surface texture, as defined by the inherent weave of the fabric. FIG. 5 shows an exemplary pattern of surface texture 15 of the second surface 11 of the fabric 8.

FIG. 6 conveniently contrasts the surface textures of the two opposed surfaces of the outer skin 7. The surface texture 14 formed on the outer skin 13 of the applied foam layer 12 may be similar to those commonly applied to imitation leather products, via a generally similar technique.

Turning now to consider FIG. 7, the above-described outer skin 7 is shown applied to the foam cover 6 of the steering wheel rim 4, in accordance with the invention. In particular, it is to be appreciated that the outer skin 7 is applied to the cover such that the second surface 15 of the fabric layer 8 faces outwardly relative to the rim 4. In other words, the outer skin 7 is applied to the cover 6 such that the fabric layer 8 is located diametrically outwardly relative to the coating 12. The coating 12 is attached to the outermost surface 16 of the underlying cover 6. This may be achieved via the application of heat (and optionally pressure) to the interface between the skin 13 of the coating and the surface 16 of the foam. Alternatively, however, the coating 12 may be adhered to the surface 16 of the foam 6 via a thin layer of suitable adhesive 17 (either water-based or solvent-based adhesive). The finely textured surface 14 of the foam skin 13 serves to ensure very good adhesion to the foam cover 6 of the rim 4.

As will thus be appreciated, the rim 4 of the steering wheel, constructed in accordance with the arrangement shown in FIG. 7, is configured to present the driver with a peripheral gripping surface defined by the second surface 11 of the fabric substrate 8. The inherent weave of the fabric 8 thus gives the peripheral surface a suitable texture.

It is envisaged that the outer skin 7 of the present invention will be formed so as to have a thickness substantially equal to that of a more conventional leather outer skin. This would permit the use of the same mould tools to create the foam cover 6, both for steering wheels formed in accordance with the present invention, and also steering wheels having an outer skin formed of leather, both such configurations of steering wheel thus effectively having the same diameter of rim when their respective outer skins are applied.

It is also envisaged that the outer skin 7 may be applied to the foam cover 6 around the rim in a plurality of separate sections, each section being connected to an adjacent one by a line of stitching running around the cross-sectional circumference of the rim.

Whilst the invention has been described above with reference to a specific embodiment, it is to be appreciated that various alterations or modifications could be made, without departing from the scope of the present invention. For example, although the embodiment described above has no coating provided on the second surface 11 of the fabric substrate 8, it is envisaged that alternative embodiments could have a coating applied to the second surface 11, providing that the coating is sufficiently thin to allow the surface texture 15 arising from the inherent weave pattern of the fabric to show through the coating. For example, the coating could take the form a thin layer of paint or varnish applied to the second surface 11 of the fabric substrate in order to increase its wear resistance.

In alternative embodiments, it is envisaged that the coating applied to the first surface 10 of the fabric substrate 8 may take the form of a layer of polychloroprene (more commonly known as “Neoprene”). In such an arrangement, it is envisaged that the layer of polychloroprene may be bonded to the first surface 11 of the fabric substrate 8 via a suitable adhesive, and also bonded to the underlying foam cover 6 using a similar adhesive. Other rubber or elastomeric substances could be used for this purpose instead of, or in combination with polychloroprene.

A steering wheel in accordance with the present invention offers a number of advantages over previously proposed types of steering wheel, particularly those which have a peripheral gripping surface formed of leather or a conventional artificial “leather-effect” covering. For example, because the steering wheel of the present invention has its peripheral surface defined by a woven fabric material, the appearance and feel of the steering wheel can be closely matched to that of the other interior features of the motor vehicle, such as the fabric of the upholstery. Also, the fabric surface of the steering wheel will mean that it is less cold to the touch in cold ambient conditions, and also less hot to the touch in hot ambient conditions.

Additionally, it has been found that in comparison to a steering wheel constructed according to the teaching of EP1055582, a steering wheel in accordance with the present invention can be manufactured without using as much adhesive to bond the outer skin 7 to the foam cover 6. In the prior art arrangement, the leather layer will absorb significantly more adhesive than the polymeric coating 12 provided on the surface 10 of the fabric layer of the present invention.

Also, it is to be appreciated that because the steering wheel of the present invention has its surface texture defined by the woven fabric, the polymeric coating 12 applied to the surface 10 of the fabric does not actually need any surface texture formed on it. This means that the mould tooling used to form the coating 12 on the fabric layer does not need any surface pattern etched or machined in to it. This makes the tooling significantly less expensive.

When used in this specification and claims, the terms “comprises” and “comprising” and variations thereof mean that the specified features, steps or integers are included. The terms are not to be interpreted to exclude the presence of other features, steps or integers.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1-15. (canceled)

16. A steering wheel comprising:
a gripping portion having an armature substantially encapsulated by a cover; and
an outer skin provided over the cover, the outer skin including a layer of fabric material defining first and second opposed surfaces, the first surface of the fabric material having a polymeric coating, the outer skin attached to an outermost surface of the cover such that the coating is interposed between the fabric layer and the cover, and the second surface defines a peripheral surface of the gripping portion.

17. The steering wheel according to claim 16, wherein the second surface of the fabric layer is substantially uncoated.

18. The steering wheel according to claim 16, wherein the second surface of the fabric layer is provided with a coating, or is painted.

19. The steering wheel according to claim 16, wherein the second surface of the fabric layer has a surface texture substantially defined by a weave of the fabric.

20. The steering wheel according to claim 16, wherein the polymeric coating has a textured surface.

21. The steering wheel according to claim 16, wherein the polymeric coating has a substantially smooth surface.

22. The steering wheel according to claim 16, wherein the polymeric coating is provided in the form of a foam layer applied to the fabric layer.

23. The steering wheel according to claim 16, wherein the polymeric coating comprises polyvinylchloride.

24. The steering wheel according to claim 16, wherein the polymeric coating comprises polyurethane.

25. The steering wheel according to claim 16, wherein The polymeric coating comprises polychloroprene.

26. The steering wheel according to claim 25, wherein the coating is adhesively secured to the fabric material.

27. The steering wheel according to claim 16, wherein the cover is formed of foam material.

28. The steering wheel according to claim 27, wherein the foam material of the cover comprises thermoplastic material.

29. The steering wheel according to claim 27, wherein the foam material of the cover comprises polyurethane.

30. The steering wheel according to claim 28, wherein the foam material of the cover comprises polyurethane.

31. The steering wheel according to claim 16, wherein the coated first surface of the fabric layer is adhesively attached to the cover.
